(19) United States
(12) Patent Application Publication
(10) Pub. No.: US 2025/0254566 A1
(43) Pub. Date: Aug. 7, 2025

(54) NETWORK LOAD MANAGEMENT BY IDENTIFYING CALL FLOWS IN RU OR CU AND DU FOR CELL-TO-POD REMAPPING

(71) Applicant: RAKUTEN SYMPHONY, INC., Tokyo (JP)

(72) Inventors: Sanjay Kumar USHAKOYALA, Bangalore, Karnataka (IN); Serene Elizabeth THOMAS, Bangalore, Karnataka (IN); Deepak KAMAT, Bangalore, Karnataka (IN)

(73) Assignee: RAKUTEN SYMPHONY, INC., Tokyo (JP)

(21) Appl. No.: 18/699,936

(22) PCT Filed: Feb. 5, 2024
(86) PCT No.: PCT/US2024/014401

§ 371 Date: Apr. 10, 2024

(51) Int. Cl. H04W 28/08

(52) U.S. Cl. CPC H04W 28/0958

(57) ABSTRACT

The present disclosure describes a method, and a system to identify call flows in Radio Unit (RU) or Centralized Unit (CU) and Distributed Units (DU) for cell-to-pod remapping. The method comprising receiving call flow traffic data of a plurality of DUs from an associated CU. Subsequently, the method comprises determining a first DU and a second DU among the plurality of DUs based on the call flow traffic data. Thereafter, the method comprises determining a new configuration for each of the first DU and the second DU based on at least one of the call flow traffic data, historical data, and pre-determined rules using a prediction model. Lastly, the method comprises transmitting the new configuration for each of the first DU and the second DU to the associated CU for remapping of a RU.

### TECHNICAL FIELD

The present disclosure relates to network load management by identifying call flows in Radio Unit (RU) or Centralized Unit (CU) and Distributed Units (DU) for cell-to-pod remapping.

### BACKGROUND ART

In a wireless communication network, when a number of User Equipments (UEs) attached to a RU exceed the limit of the RU, the RU, which is considered to be heavily loaded, does not accept a connection request from a new UE. In this situation, a different RU, which is less loaded, will accept the connection request from the new UE. This type of UE connection to a RU unit may result in an inefficient network resource utilization. However, there is no mechanism available for load balancing of DU by disassociating the RU from heavily loaded DU and associating the same to less loading DU.

The information disclosed in this background of the disclosure section is only for enhancement of understanding of the general background of the invention and should not be taken as an acknowledgement or any form of suggestion that this information forms the prior art already known to a person skilled in the art.

### SUMMARY

The present disclosure tries to address the aforesaid problem associated with network resource utilization.

In an embodiment, the present disclosure relates to a method. The method comprising receiving call flow traffic data of a plurality of Distributed Units (DUs) from an associated Centralized Unit (CU). Subsequently, the method comprising determining a first DU and a second DU among the plurality of DUs based on the call flow traffic data. Thereafter, the method comprising determining a new configuration for each of the first DU and the second DU based on at least one of the call flow traffic data, historical data, and pre-determined rules using a prediction model. Lastly, the method comprising transmitting the new configuration for each of the first DU and the second DU to the associated CU for remapping of a Radio Unit (RU).

In another embodiment, the present disclosure relates to a system comprising an EMS. The EMS is configured to receive call flow traffic data of a plurality of DUs from an associated CU. Subsequently, the EMS is configured to determine a first DU and a second DU among the plurality of DUs based on the call flow traffic data. Thereafter, the EMS is configured to determine a new configuration for each of the first DU and the second DU based on at least one of the call flow traffic data, historical data, and pre-determined rules using a prediction model. Lastly, the EMS is configured to transmit the new configuration for each of the first DU and the second DU to the associated CU for remapping of a RU.

In yet another embodiment, the present disclosure relates to a non-transitory computer readable medium. The non-transitory computer readable medium includes instructions stored thereon that when processed by at least one processor cause an EMS to perform operations comprising receiving call flow traffic data of a plurality of DUs from an associated CU. Subsequently, the instructions cause the at least one processor to determine a first DU and a second DU among the plurality of DUs based on the call flow traffic data. Thereafter, the instructions cause the at least one processor to determine a new configuration for each of the first DU and the second DU based on at least one of the call flow traffic data, historical data, and pre-determined rules using a prediction model. Lastly, the instructions cause the at least one processor to transmit the new configuration for each of the first DU and the second DU to the associated CU for remapping of a RU.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and together with the description, serve to explain the disclosed principles. In the figures, the left-most digit(s) of a reference number identifies the figure in which the reference number first appears. The same numbers are used throughout the figures to reference like features and components. Some embodiments of system and methods in accordance with embodiments of the present subject matter are now described below, by way of example only, and with reference to the accompanying figures.

FIG. 1 illustrates an environment for identifying call flows in RU or CU and DU for cell-to-pod remapping in accordance with some embodiments of the present disclosure.

FIG. 2 shows a detailed block diagram of an EMS in accordance with some embodiments of the present disclosure.

FIG. 3 illustrates a flowchart showing a method for identifying call flows in RU or CU and DU for cell-to-pod remapping in accordance with some embodiments of the present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

TABLE 1

| Abbreviation | Description |
|---|---|
| UE | User equipment |
| LTE | Long Term Evolution |
| 5G | Fifth Generation cellular network technology |
| 6G | Sixth Generation cellular network technology |
| NG | Next Generation |
| EMS | Element Management System |
| DU | Distributed Unit |
| CU | Centralized Unit |
| RU | Radio Unit |
| API | Application Programming Interface |
| M-plane | Management plane |
| RAN | Radio Access Network |
| SMO | Standardized Management and Orchestration |
| RIC | RAN Intelligent Controller |
| ARIMA | Auto Regressive Integrated Moving Average |
| I-O interface | Input-Output interface |
| CDMA | Code-Division Multiple Access |
| HSPA+ | High-Speed Packet Access |
| GSM | Global System for Mobile communications |
| GPS | Global Positioning System |
| SPF | Sun Protection Factor |
| LTE | Long-Term Evolution |
| WiMax | Worldwide interoperability for Microwave access |
| RAID | Redundant Array of Independent Discs |
| ASIC | Application Specific Integrated Circuit |
| FPGA | Field-Programmable Gate Arrays |
| PGA | Programmable Gate Array |
| ASIC | Application Specific Integrated Circuit |
| RAM | Random Access Memory |
| ROM | Read-Only Memory |

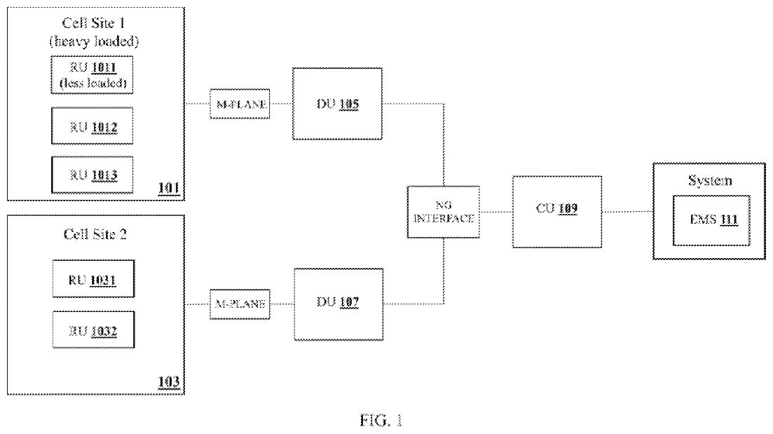

FIG. 1 illustrates an environment for identifying call flows in RU or CU and DU for cell-to-pod remapping in accordance with some embodiments of the present disclosure.

With reference to FIG. 1, the environment comprises of a plurality of cell sites 101, 103, a plurality of DUs 105, 107, a CU 109, and an EMS 111. In an embodiment, the EMS 111 is part of a system. In another embodiment, the plurality of DUs 105, 107, the CU 109, and the EMS 111 are part of the system. The plurality of cell sites 101, 103 comprises a cell site 101 and a cell site 103. For sake of explanation, only two cell sites i.e., the cell site 101 and the cell site 103 and two DUs 105, 107 have been shown. However, there could be more than two cell sites and two DUs. Further, each of the plurality of cell sites 101, 103 comprises two or more RUs. The cell site 101 comprises, but not limited to, RU 1011, RU 1012, and RU 1013. The cell site 103 comprises, but not limited to, RU 1031, and RU 1032. Each RU of the cell site 101 and cell site 103 is communicatively connected to one or more UEs (not shown in FIG. 1). The RU 1011, RU 1012, and RU 1013 of the cell site 101 is communicatively connected to a DU 105 of the plurality of DUs 105, 107 through a M-plane. Similarly, the RU 1031, and RU 1032 of the cell site 103 is communicatively connected to a DU 107 of the plurality of DUs 105, 107 through the M-plane. Each of the plurality of DUs 105, 107 is communicatively connected to the CU 109 through a F-1 interface. The CU 109 is communicatively connected to the EMS 111 through NG interface. In one embodiment, a network analyser is part of the CU 109. In another embodiment, the network analyser is part of the EMS 111. In an embodiment, the EMS 111 comprises a SMO platform, a non real-time RIC, and a near real-time RIC (not shown in FIG. 1).

The operation for identifying call flows in RU or CU and DU for cell-to-pod remapping is explained with reference to FIG. 1.

The cell site 101 of the plurality of cell sites 101, 103 is considered to have high data traffic as compared to the cell site 103 of the plurality of cell sites 101, 103. Each of the plurality of DUs 105, 107 receive call flow traffic data from associated cell site. The DU 105 receives call flow traffic data from each RU 1011, RU 1012, and RU 1013 of the cell site 101. Similarly, the DU 107 receives call flow traffic data from each RU 1031, and RU 1032 of the cell site 103. The call flow traffic data comprises, but not limited to, cell site statistics, weather data, and geographical data. The cell site statistics comprises data rate, allocated bandwidth, and number of attached UEs. The weather data comprises GPS satellite count (i.e., GPS satellite count less indicates weather being more cloudy, and GPS satellite count more indicates weather being clear or less cloudy), and SPF temperature (i.e., less SPF temperature indicates a RU being in cold climate, and more SPF temperature indicates the RU being in hot or tropical climate). The geographical data comprises GPS location with which the EMS 111 can get real-time weather from an internet.

The use of cell site statistics from each cell site for managing the network load improves the bandwidth for the users and uptime for cell sites. Thereafter, the DU 105 transmits the call flow traffic data received from each RU 1011, RU 1012, and RU 1013 of the cell site 101 to the CU 109. Similarly, the DU 107 transmits the call flow traffic data received from each RU 1031, and RU 1032 of the cell site 103 to the CU 109.

When the network analyser is part of the EMS 111, the EMS 111 receives the call flow traffic data of the plurality of DUs 105, 107 from the CU 109. The network analyser of the EMS 111 determines a first DU and a second DU among the plurality of DUs 105, 107 based on the call flow traffic data. Since the cell site 101 is considered to have high data traffic as compared to the cell site 103, the network analyser of the EMS 111 determines the DU 105 as the first DU and the DU 107 as the second DU based on the call flow traffic data. The network analyser of the EMS 111 determines that the RU 1012 and the RU 1013 have high data traffic compared to the RU 1011 in the cell site 101.

When the network analyser is part of the CU 109, the network analyser of the CU 109 determines a first DU and a second DU among the plurality of DUs 105, 107 based on the call flow traffic data. The first DU is a DU with a high data traffic and the second DU is a DU with a low data traffic. Since the cell site 101 is considered to have high data traffic as compared to the cell site 103, the network analyser of the CU 109 determines the DU 105 as the first DU and the DU 107 as the second DU based on the call flow traffic data. The network analyser of the CU 109 determines that the RU 1012 and the RU 1013 have high data traffic compared to the RU 1011 in the cell site 101. Thereafter, the CU 109 transmits at least one of the call flow traffic data of the plurality of DUs 105, 107 and an information on the first DU and the second DU. The information on the first DU and the second DU comprises information that the DU 105 is having a high data traffic, and the second DU is the DU 107 having a low data traffic.

The EMS 111 determines a new configuration for each of the first DU and the second DU based on at least one of the call flow traffic data, historical data, and pre-determined rules using a prediction model. The historic data (also, referred as data from past) comprises, but not limited to, data relating to at least one of data traffic during day time and night time, data traffic based on temperature changes, and data traffic during peak times. The predetermined rules include, but not limited to, rules pertaining to at least one of performing load balancing in night time, performing load balancing when UE traffic is less, and performing load balancing just before traffic load increase. This approach of utilizing comprehensive data such as call flow traffic data, and historical data and prediction model helps in determining optimal configuration that effectively balances the load on each DU. The prediction model is, but not limited to, a linear regression model. In an embodiment, the linear regression model is an ARIMA model. In brief, the EMS 111 utilizes at least one of the call flow traffic data, historical data, and pre-determined rules using the prediction model to come up with a configuration which will balance the network load between the DUs 105, 107.

The EMS 111 transmits the new configuration for each of the first DU and the second DU to the associated CU for remapping of a RU. The EMS 111 transmits the new configuration for each of the DU 105 and the DU 107 to the CU 109 for remapping of the RU 1011.

When EMS 111 comprises the SMO platform, the non real-time RIC, and the near real-time RIC, the non real-time RIC of the EMS 111 receives at least one of the call flow traffic data, the historical data, and the pre-determined rules from the SMO platform of the EMS 111. Thereafter, the non real-time RIC of the EMS 111 determines the new configuration for each of the first DU and the second DU based on at least one of the call flow traffic data, the historical data, and the pre-determined rules using the prediction model. Thereafter, the new configuration for each of the first DU and the second DU is sent to the near real-time RIC of the EMS 111 from where the new configuration for each of the first DU and the second DU is sent to the SMO platform of the EMS 111. The SMO platform of the EMS 111 transmits the new configuration for each of the first DU and the second DU to the associated CU for remapping of the RU. The non real-time RIC, and the near real-time RIC are communicatively connected using a A1 interface. The near real-time RIC and non real-time RIC are communicatively connected to the SMO platform using an O1 interface.

Upon receiving the new configuration for each of the first DU and the second DU, the associated CU transmits the new configuration to each of the first DU and the second DU. The CU 109 transmits the new configuration of the DU 105 to the DU 105 and the new configuration of the DU 107 to the DU 107.

Upon receiving the new configuration from the CU 109, the first DU and the second DU update a current configuration with the new configuration for remapping of the RU. Thereafter, the first DU applies the new configuration to detach the RU from the first DU. Similarly, the second DU applies the new configuration to attach the RU to the second DU. The DU 105 updates its current configuration with the new configuration received from the CU 109 for remapping the RU 1011 from the cell site 101 to the cell site 103. Thereafter, the DU 105 applies the new configuration to detach the RU 1011 from the DU 107. Similarly, the DU 107 updates its current configuration with the new configuration received from the CU 109 for remapping the RU 1011 from the cell site 101 to the cell site 103. Thereafter, the DU 107 applies the new configuration to attach the RU 1011 to the DU 107. When the new configuration is updated or applied at the DU 105, a M-Plane API is initiated from the DU 105 to detach the RU 1011 from the DU 105. Once a UE handover is completed with respect to the RU 1011, the RU 1011 is instigated to attach to the DU 107 as per the new configuration. The effective load balancing achieved using this approach, consequently, results in efficient utilization of RU resource and improved performance of RU-DU units.

The system and the method of the present disclosure for identifying call flows in RU or CU and DU for cell-to-pod remapping is applicable to, but not limited to, LTE, 5G, and 6G wireless communication network.

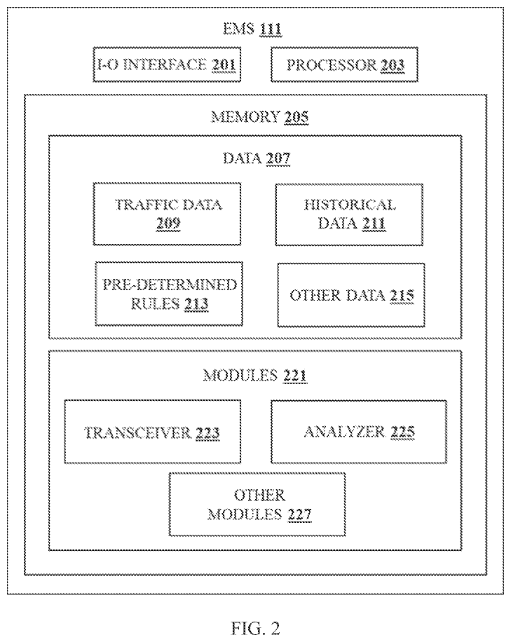

FIG. 2 shows a detailed block diagram of an EMS in accordance with some embodiments of the present disclosure.

The EMS 111 may include an I-O interface 201, a processor 203, data 207, and one or more modules 221 (also, referred as modules), which are described herein in detail.

The EMS 111 may communicate with the associated CU 109 via the I-O interface 201. The I-O interface 201 may employ communication protocols or methods such as, without limitation, Bluetooth, cellular e.g., CDMA, HSPA+, GSM, LTE, NR, WiMax, NG interface, or the like.

The processor 203 may include at least one data processor for identifying call flows in RU or CU and DU for cell-to-pod remapping. The processor 203 may include specialized processing units such as, without limitation, integrated system (bus) controllers, memory management control units, floating point units, graphics processing units, digital signal processing units, etc.

In an embodiment, the data 207 may be stored within the memory 205. The memory 205 may be communicatively coupled to the processor 203 of the EMS 111. The memory 205 may, also, store processor instructions which may cause the processor 203 to execute the instructions for identifying call flows in RU or CU and DU for cell-to-pod remapping. The memory 205 may include, without limitation, memory drives, etc. The memory drives may further include a drum, magnetic disc drive, magneto-optical drive, optical drive, RAID, solid-state memory devices, solid-state drives, etc.

The data 207 may include, for example, traffic data 209, historical data 211, pre-determined rules 213, and other data 215.

The traffic data 209 may store call flow traffic data received from the associated CU 109. The call flow traffic data may comprise cell site statistics, weather data, and geographical data.

The historic data 211 may store data relating to at least one of data traffic during day time and night time, data traffic based on temperature changes, and data traffic during peak times.

The predetermined rules 213 may store rules pertaining to at least one of performing load balancing in night time, performing load balancing when UE traffic is less, and performing load balancing just before traffic load increase.

The other data 215 may store data, including temporary data and temporary files, generated by one or more modules 221 for performing the various functions of the EMS 111.

In an embodiment, the data 207 in the memory 205 are processed by the one or more modules 221 present within the memory 205 of the EMS 111. The one or more modules 221 may be implemented as dedicated hardware units. As used herein, the term module refers to at least one of an ASIC, an electronic circuit, a FPGA, a combinational logic circuit, and other suitable components that provide the described functionality. In some implementations, the one or more modules 221 may be communicatively coupled to the processor 203 for performing one or more functions of the EMS 111. The one or more modules 221 when configured with the functionality defined in the present disclosure will result in a novel hardware.

In one implementation, the one or more modules 221 may include, but are not limited to, a transceiver 223, and an analyzer 225. The one or more modules 221 may, also, include other modules 227 to perform various miscellaneous functionalities of the EMS 111.

Transceiver 223: The transceiver 223 may receive call flow traffic data of a plurality of DUs 105, 107 from the associated CU 109.

When the analyzer 225 determines a new configuration for each of the first DU 105 and the second DU 107, the transceiver 223 may transmit the new configuration for each of the first DU 105 and the second DU 107 to the associated CU 109 for remapping of a RU 1011.

Analyzer 225: The analyzer 225 may determine a first DU 105 and a second DU 107 among the plurality of DUs 105, 107 based on the call flow traffic data received from the associated CU 109.

The analyzer 225 may determine a new configuration for each of the first DU 105 and the second DU 107 based on at least one of the call flow traffic data, historical data, and pre-determined rules using a prediction model. In an embodiment, the prediction model is part of the analyzer 225. The prediction model is, but not limited to, a linear regression model.

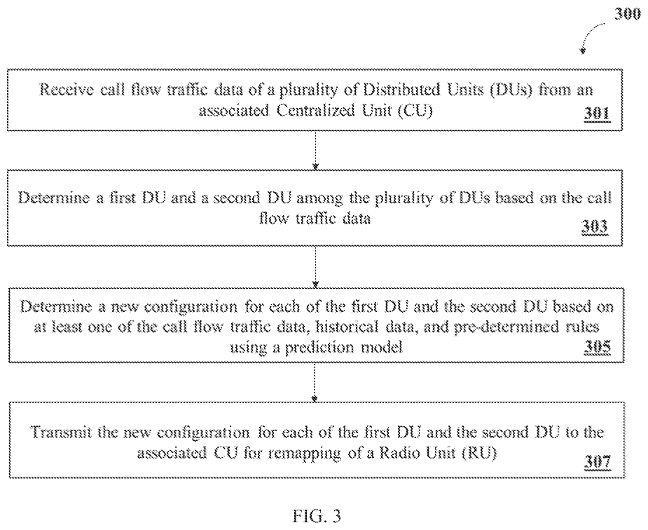

FIG. 3 illustrates a flowchart showing a method for identifying call flows in RU or CU and DU for cell-to-pod remapping in accordance with some embodiments of the present disclosure.

As illustrated in FIG. 3, the method 300 includes one or more blocks for identifying call flows in RU or CU and DU for cell-to-pod remapping in accordance with some embodiments of the present disclosure. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, the transceiver 223 of the EMS 111 receives call flow traffic data of a plurality of DUs 105, 107 from an associated CU 109. The call flow traffic data comprises cell site statistics, weather data, and geographical data.

At block 303, the analyzer 225 of the EMS 111 determines a first DU 105 and a second DU 107 among the plurality of DUs 105, 107 based on the call flow traffic data. The first DU 105 is a DU with a high data traffic and the second DU 107 is a DU with a low data traffic.

At block 305, the analyzer 225 of the EMS 111 determines a new configuration for each of the first DU 105 and the second DU 107 based on at least one of the call flow traffic data, historical data, and pre-determined rules using a prediction model. The prediction model is a linear regression model.

At block 307, the transceiver 223 of the EMS 111 transmits the new configuration for each of the first DU 105 and the second DU 107 to the associated CU 109 for remapping of a RU 1011.

Some of the advantages of the present disclosure are listed below.

The present disclosure remaps RU-DU links based on at least one of the call flow traffic data (comprising cell site statistics, weather data, and geographical data), historical data, and a prediction model. This approach of utilizing comprehensive data such as call flow traffic data, and historical data and prediction model helps in determining optimal configuration that effectively balances the load on each DU by re-linking the RU(s). Further, information from the comprehensive data such as call flow traffic data, and historical data and prediction model allows managing DU(s)/RU(s) efficiently in terms of adding or reducing DU(s)/RU(s) to the cell site.

The effective load balancing achieved in the present disclosure, consequently, results in efficient utilization of RU resource and improved performance of RU-DU units.

The present disclosure improves the bandwidth for the users and uptime for cell sites by making use of cell site statistics for each cell site for managing the network load.

The present disclosure provides the possibility to build new call flows on the existing network architecture.

Some of the clauses are mentioned below.

[1]: A method comprising:
receiving, by an Element Management System (EMS), call flow traffic data of a plurality of Distributed Units (DUs) from an associated Centralized Unit (CU);
determining, by the EMS, a first DU and a second DU among the plurality of DUs based on the call flow traffic data;
determining, by the EMS, a new configuration for each of the first DU and the second DU based on at least one of the call flow traffic data, historical data, and pre-determined rules using a prediction model; and
transmitting, by the EMS, the new configuration for each of the first DU and the second DU to the associated CU for remapping of a Radio Unit (RU).

[2]: The method described in [1], further comprising:
transmitting, by the associated CU, the new configuration to each of the first DU and the second DU; and
updating, by the first DU and the second DU, a current configuration with the new configuration for remapping of the RU.

[3]: The method described in any one of [1] to [2], further comprising:
applying, by the first DU, the new configuration to detach the RU from the first DU; and
applying, by the second DU, the new configuration to attach the RU to the second DU.

[4]: The method described in any one of [1] to [3], wherein the call flow traffic data comprises cell site statistics, weather data, and geographical data.

[5]: The method described in any one of [1] to [4], wherein the prediction model is a linear regression model.

[6]: The method described in any one of [1] to [5], wherein the first DU is a DU with a high data traffic and the second DU is a DU with a low data traffic.

[7]: The method described in any one of [1] to [6], wherein prior to receiving call flow traffic data of the plurality of DUs from the associated CU, the method comprising:
receiving, by the associated CU, the call flow traffic data from the plurality of DUs.

[8]: A system, comprising:
an Element Management System (EMS) comprising:
a processor; and
a memory communicatively coupled to the processor, wherein the memory stores processor-executable instructions, which on execution, cause the processor to:
receive call flow traffic data of a plurality of Distributed Units (DUs) from an associated Centralized Unit (CU);
determine a first DU and a second DU among the plurality of DUs based on the call flow traffic data;
determine a new configuration for each of the first DU and the second DU based on at least one of the call flow traffic data, historical data, and pre-determined rules using a prediction model; and
transmit the new configuration for each of the first DU and the second DU to the associated CU for remapping of a Radio Unit (RU).

[9]: The system described in [8], further comprising:
the associated CU configured to:
transmit the new configuration to each of the first DU and the second DU; and
the first DU and the second DU configured to:
update a current configuration with the new configuration for remapping of the RU.

[10]: The system described in any one of [8] to [9], further comprising:
the first DU is configured to:
apply the new configuration to detach the RU from the first DU; and
the second DU is configured to:
apply the new configuration to attach the RU to the second DU.

[11]: The system described in any one of [8] to [10], wherein the call flow traffic data comprises cell site statistics, weather data, and geographical data.

[12]: The system described in any one of [8] to [11], wherein the prediction model is a linear regression model.

[13]: The system described in any one of [8] to [12], wherein the first DU is a DU with a high data traffic and the second DU is a DU with a low data traffic.

[14]: The system described in any one of [8] to [13], further comprising:
the associated CU configured to:
receive the call flow traffic data from the plurality of DUs.

[15]: A non-transitory computer readable medium including instructions stored thereon that when processed by at least one processor cause an Element Management System (EMS) of a system to perform operations comprising:
receiving call flow traffic data of a plurality of Distributed Units (DUs) from an associated Centralized Unit (CU);
determining a first DU and a second DU among the plurality of DUs based on the call flow traffic data;
determining a new configuration for each of the first DU and the second DU based on at least one of the call flow traffic data, historical data, and pre-determined rules using a prediction model; and
transmitting the new configuration for each of the first DU and the second DU to the associated CU for remapping of a Radio Unit (RU).

[16]: The computer readable medium described in [15],
wherein the instructions cause the associated CU to perform operations comprising:
transmitting the new configuration to each of the first DU and the second DU; and
wherein the instructions cause the first DU and the second DU to perform operations comprising:
updating a current configuration with the new configuration for remapping of the RU.

[17]: The computer readable medium described in any one of [15] to [16],
wherein the instructions cause the first DU to perform operations comprising:
applying the new configuration to detach the RU from the first DU; and
wherein the instructions cause the second DU to perform operations comprising:
applying the new configuration to attach the RU to the second DU.

[18]: The computer readable medium described in any one of [15] to [17],
wherein the call flow traffic data comprises cell site statistics, weather data, and geographical data; and
wherein the prediction model is a linear regression model.

[19]: The computer readable medium described in any one of [15] to [18], wherein the first DU is a DU with a high data traffic and the second DU is a DU with a low data traffic.

[20]: The computer readable medium described in any one of [15] to [19], wherein prior to receiving call flow traffic data of the plurality of DUs from the associated CU, the instructions cause the associated CU to perform operations comprising:
receiving the call flow traffic data from the plurality of DUs.

With respect to the use of substantially any plural and singular terms herein, those having skill in the art can translate from the plural to the singular and from the singular to the plural as is appropriate to the context or application. The various singular or plural permutations may be expressly set forth herein for sake of clarity.

One or more computer-readable storage media may be utilized in implementing embodiments consistent with the present disclosure. A computer-readable storage medium refers to any type of physical memory on which a software (program) readable by an information processing apparatus may be stored. The information processing apparatus includes a processor and a memory, and the processor executes a process of the software. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include RAM, ROM, volatile memory, non-volatile memory, hard drives, CD ROMs, DVDs, flash drives, disks, and any other known physical storage media.

The described operations may be implemented as a method, a system, or an article of manufacture using at least one of standard programming and engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMS, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, PGA, ASIC, etc.).

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device or article (whether or not they cooperate) may be used in place of a single device or article. Similarly, where more than one device or article is described herein (whether or not they cooperate), it will be readily apparent that a single device or article may be used in place of the more than one device, or article, or a different number of devices or articles may be used instead of the shown number of devices or programs. At least one of the functionalities and the features of a device may be alternatively embodied by one or more other devices which are not explicitly described as having such functionality or features. Thus, other embodiments of the invention need not include the device itself.

The illustrated operations of FIG. 3 show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

### REFERRAL NUMERALS

| Reference number | Description |
|---|---|
| 101 | Cell site 1 |
| 1011, 1012, 1013 | RU of cell site 1 |
| 103 | Cell site 2 |
| 1031, 1032 | RU of cell site 2 |
| 105, 107 | DU |
| 109 | CU |
| 111 | EMS |
| 201 | I-O interface |
| 203 | Processor |
| 205 | Memory |
| 207 | Data |
| 209 | Traffic data |
| 211 | Historical data |
| 213 | Pre-determined rules |
| 215 | Other data |
| 221 | Modules |
| 223 | Transceiver |
| 225 | Analyzer |
| 227 | Other modules |

We claim:

1. A method comprising:
receiving call flow traffic data of a plurality of Distributed Units (DUs) from an associated Centralized Unit (CU);
determining a first DU and a second DU among the plurality of DUs based on the call flow traffic data;
determining a new configuration for each of the first DU and the second DU based on at least one of the call flow traffic data, historical data, and pre-determined rules using a prediction model; and
transmitting the new configuration for each of the first DU and the second DU to the associated CU for remapping of a Radio Unit (RU).

2. The method as claimed in claim 1, further comprising:
transmitting, by the associated CU, the new configuration to each of the first DU and the second DU; and
updating, by the first DU and the second DU, a current configuration with the new configuration for remapping of the RU.

3. The method as claimed in claim 2, further comprising:
applying, by the first DU, the new configuration to detach the RU from the first DU; and
applying, by the second DU, the new configuration to attach the RU to the second DU.

4. The method as claimed in claim 1, wherein the call flow traffic data comprises cell site statistics, weather data, and geographical data.

5. The method as claimed in claim 1, wherein the prediction model is a linear regression model.

6. The method as claimed in claim 1, wherein the first DU is a DU with a high data traffic and the second DU is a DU with a low data traffic.

7. The method as claimed in claim 1, wherein prior to receiving call flow traffic data of the plurality of DUs from the associated CU, the method comprising:
receiving, by the associated CU, the call flow traffic data from the plurality of DUs.

8. A system, comprising:
an Element Management System (EMS) configured to:
receive call flow traffic data of a plurality of Distributed Units (DUs) from an associated Centralized Unit (CU);
determine a first DU and a second DU among the plurality of DUs based on the call flow traffic data;
determine a new configuration for each of the first DU and the second DU based on at least one of the call flow traffic data, historical data, and pre-determined rules using a prediction model; and
transmit the new configuration for each of the first DU and the second DU to the associated CU for remapping of a Radio Unit (RU).

9. The system as claimed in claim 8, further comprising:
the associated CU configured to:
transmit the new configuration to each of the first DU and the second DU; and
the first DU and the second DU configured to:
update a current configuration with the new configuration for remapping of the RU.

10. The system as claimed in claim 9, further comprising:
the first DU is configured to:
apply the new configuration to detach the RU from the first DU; and
the second DU is configured to:
apply the new configuration to attach the RU to the second DU.

11. The system as claimed in claim 8, wherein the call flow traffic data comprises cell site statistics, weather data, and geographical data.

12. The system as claimed in claim 8, wherein the prediction model is a linear regression model.

13. The system as claimed in claim 8, wherein the first DU is a DU with a high data traffic and the second DU is a DU with a low data traffic.

14. The system as claimed in claim 8, further comprising:
the associated CU configured to:
receive the call flow traffic data from the plurality of DUs.

15. A non-transitory computer readable medium including instructions stored thereon that when processed cause an Element Management System (EMS) of a system to perform operations comprising:
receiving call flow traffic data of a plurality of Distributed Units (DUs) from an associated Centralized Unit (CU);
determining a first DU and a second DU among the plurality of DUs based on the call flow traffic data;
determining a new configuration for each of the first DU and the second DU based on at least one of the call flow traffic data, historical data, and pre-determined rules using a prediction model; and
transmitting the new configuration for each of the first DU and the second DU to the associated CU for remapping of a Radio Unit (RU).

16. The computer readable medium as claimed in claim 15,
wherein the instructions cause the associated CU to perform operations comprising:
transmitting the new configuration to each of the first DU and the second DU; and
wherein the instructions cause the first DU and the second DU to perform operations comprising:
updating a current configuration with the new configuration for remapping of the RU.

17. The computer readable medium as claimed in claim 16,
wherein the instructions cause the first DU to perform operations comprising:
applying the new configuration to detach the RU from the first DU; and
wherein the instructions cause the second DU to perform operations comprising:
applying the new configuration to attach the RU to the second DU.

18. The computer readable medium as claimed in claim 15,
wherein the call flow traffic data comprises cell site statistics, weather data, and geographical data; and
wherein the prediction model is a linear regression model.

19. The computer readable medium as claimed in claim 15, wherein the first DU is a DU with a high data traffic and the second DU is a DU with a low data traffic.

20. The computer readable medium as claimed in claim 15, wherein prior to receiving call flow traffic data of the plurality of DUs from the associated CU, the instructions cause the associated CU to perform operations comprising:
receiving the call flow traffic data from the plurality of DUs.
